(19) United States
(12) Patent Application Publication
(10) Pub. No.: US 2011/0260077 A1
(43) Pub. Date: Oct. 27, 2011

(54) DISINFECTING LIQUID DISPENSER

(76) Inventor: Jeffrey D. Boschert, Pleasant Hill, CA (US)

(21) Appl. No.: 12/765,599

(22) Filed: Apr. 22, 2010

(51) Int. Cl. G01N 23/12

(52) U.S. Cl. 250/432 R

(57) ABSTRACT

A disinfecting liquid dispenser comprises a bowl for holding liquid, and a tube for drawing liquid out of the bowl. Liquid passes through the tube by action of a pump. The tube carrying the liquid is held within a housing adjacent to or integrally constructed with the bowl. The tube is formed of a light transmissive or transparent material. The tube is within a housing of a disinfecting section. Within the housing of the disinfecting section there is an ultraviolet light generator, which shines UV light on the liquid as it passes through the tube being pumped through the housing of the disinfecting section. The liquid exits the tube through an outlet and passes down a return ramp back to the bowl. In one embodiment, the return ramp includes a light transmissive window through which the UV light shines UV light on liquid passing over the window. In this manner, water or liquid circulating through the system is disinfected and aerated. A disinfecting liquid dispenser is suitable for use with pets for providing a longer-lasting supply of fresh and uncontaminated drinking water.

### BACKGROUND OF THE INVENTION

(a) Field of the Invention

The invention generally relates to the field of dispensing and disinfecting liquids, such as a water dispenser for a pet, and methods for dispensing the same.

(b) Description of the Related Art

Pets such as cats and dogs require liquid nourishment, including especially water. Traditional water bowls for pets are simple bowls which are filled manually by a pet handler. Plain water bowls do not circulate the water. Water left standing in bowls over time risks contamination or growth of bacteria, viruses, mold spores, funguses, oocysts, other biological contaminants, or other micro-organisms in the water. Over a sufficiently long period of time, water left standing in a bowl risks becoming unhealthy for a pet to drink due to contamination of the water from the environment. In those circumstances where a user owns multiple pets sharing the same drinking source, multiple animals drinking from the same water bowl risk continually contaminating the bowl each time they use it.

There are a number of drawbacks associated with the use of water bowls for pets. For example, even if water is manually changed in such bowls by a pet owner, there is a risk of buildup of contaminants in the bowl over time. Over time, the water can become polluted, dirty, or infected, and the interior walls of the bowl tend to then become areas on which micro-organisms can grow. The growth of micro-organisms often requires the owner or caretaker of the pet to change the water more frequently than may otherwise be necessary. Also, the risk of growth of micro-organisms necessitates washing of the bowl on a regular, often frequent basis. Because water bowls are intended for pets to imbibe liquids, using antibacterial or disinfectant additives or chemicals added to the water is undesirable since such additives or chemicals may not be healthy for the pet to consume. Also, such additives or chemicals may have a taste or odor which are undesirable or unpalatable to a pet, thus diminishing a pet's frequency of drinking of water to perhaps unhealthful levels.

Systems for filtering water for a pet bowl are known which use mechanical or charcoal/carbon filters. Water bowls using a mechanical or carbon filter are made by a variety of manufacturers. Examples of such filtered water bowls include the commercially-available “Dogit Fresh & Clear Drinking Water Fountain for Dogs” (see http://www.smarthome.com/61872/Dogit-Fresh-Clear-Drinking-Water-Fountain-for-Dogs-Large-73651/p.aspx) or the “Drinkwell Platinum Pet Fountain” (see http://www.nextag.com/Ergo-2000SW-Filtered-Pet-509760298/prices-html).

The desire on the part of pet owners to provide water which is relatively free of contaminants raises several issues which existing filtered water bowls, such as those discussed above, cannot solve. Traditional water bowls have no way to reduce contaminants other than through manual washing by an owner. Filtered water bowls rely upon physical filters made of mesh to remove particles greater than a given size from the water, but have no means to effectively reduce biological contaminants. Water bowls using charcoal/carbon filters may not remove a sufficiently large percentage of biological contaminants to satisfy a pet owner's concerns. Also, charcoal/carbon filters must be changed to maintain effectiveness. Misalignment or misinsertion of a charcoal/carbon filter in a system can also result in loss of filtering effectiveness. Finally, a charcoal/carbon filter's use over time may impact the taste or odor of a liquid, which some pets may find undesirable.

If a pet owner wishes to make water available for a pet for a longer period of time without the owner having to wash or change the water bowl, the owner must use a bowl equipped with a mechanical or charcoal/carbon filter. If a pet owner wishes to make drinking water available for a pet untended for a length of time (for example, during a long work day for a cat or dog, or longer than one day in the case of more independent or less water-needy pets), such pet owner is currently only able to provide water with a traditional bowl, or a filtered water bowl, which may risk nutritional deficiencies and health problems for the pet. Some commercially available watering bowls include an attached reservoir tank and pump for providing additional water than can be held by one bowl, such as the “Ergo 2000SW Filtered Pet Waterer” (see http://www.nextag.com/Ergo-2000SW-Filtered-Pet-509760298/prices-html). However such commercially available water reservoir systems still rely on charcoal filtering and the water in the reservoir remains uncirculated while stored. Alternatively, such a pet owner's other option is to burden another person, who may or may not be familiar with the pet, by asking them to tend for the changing of the water bowl for the pet manually, which poses a risk of underwatering if the person asked to care for the pet has insufficient knowledge of the amount of water a pet needs, and thus creates a risk of health problems or distress for the pet.

More generally, all these commercially available water bowls are intended to be used with tap water and when used with tap water, such water may be contaminated to some extent and does not have the benefit of continuous disinfection. As discussed, every time an animal drinks from a water bowl, those of ordinary skill will understand that the animal will further contaminate the water through saliva and touching the water while drinking. Thus, there exists a continuing risk of contamination of these water bowls as they are used over time.

Accordingly, an automated system and method for dispensing disinfected liquid is desired. Accordingly, dispensers that provide reasonable disinfecting properties to liquids, and are relatively easy to implement and maintain are desirable. Also, dispensers that are capable of continually disinfecting and circulating water are desirable.

### SUMMARY OF THE INVENTION

According to one aspect of an embodiment in accordance with the principles of the present invention, a system for dispensing disinfected liquid comprises a liquid containing portion containing a liquid, a disinfecting portion in liquid communication with said liquid containing portion, a pump for pumping liquid from the liquid containing portion through the disinfecting portion and back to the liquid containing portion, a sterilizer for sterilizing said liquid as it passes through the disinfecting section, wherein said sterilizer generates ultraviolet light sufficient to have anti-bacterial effect on the liquid as it passes through the disinfecting section.

In another aspect, a system in accordance with an embodiment of the principles of the present invention includes an apparatus for providing disinfected liquid suitable for use with a pet comprising, a bowl containing a liquid, said bowl having sidewalls and a bottom surface, a sterilizer mounted within the interior of the structure of said bowl, said sterilizer generating ultraviolet light and arranged so as to direct said ultraviolet light at a liquid held within the concavity of said bowl, whereby the sterilizer provides antibacterial effect for sterilizing the liquid held within said bowl.

In another aspect, a system in accordance with an embodiment of the principles of the present invention includes concavity holding a liquid, a tube in fluid communication with said liquid, said tube connected to a pump mounted within a housing adjacent to said concavity, said tube formed of a light transmissive material, a UV light generator mounted adjacent to said tube, said tube having an outlet whereby said pump pumps liquid through said tube and out said outlet onto a return having a light transmissive window, whereby said sterilizer is mounted adjacent to said window, wherein said liquid exiting said outlet travels over said window, and is sterilized by said UV light generator, wherein liquid cycles through said dispenser system from said concavity and back to said concavity while being sterilized by said UV light generator.

In yet another aspect, a system in accordance with an embodiment of the principles of the present invention includes a UV light generator mounted in line with said tube. These and other aspects of the invention will be more apparent in view of the following detailed description of the exemplary embodiments and the accompanying drawings thereof.

### BRIEF DESCRIPTION OF THE DRAWINGS

For a more complete understanding of the present invention and for further features and advantages, reference is now made to the following description taken in conjunction with the accompanying drawings.

FIG. 1 is a cross-sectional block diagram view of one embodiment of a system in accordance with the present invention.

FIG. 2 is a cross-section view of another embodiment of a system in accordance with the present invention.

FIG. 3 is a cross-section view of another embodiment of a system in accordance with the present invention.

FIG. 3 is a cross-section view of another embodiment of a system in accordance with the present invention.

FIG. 4 is a cross-section view of another embodiment of a system in accordance with the present invention.

FIG. 5 is a cross-section view of another embodiment of a system in accordance with the present invention.

FIG. 6 is a cross-section view of another embodiment of a system in accordance with the present invention.

FIG. 7 is a cross-section view of another embodiment of a system in accordance with the present invention.

In the drawings, like features are typically labeled with the same reference numbers across the various drawings.

### DETAILED DESCRIPTION OF THE EMBODIMENTS

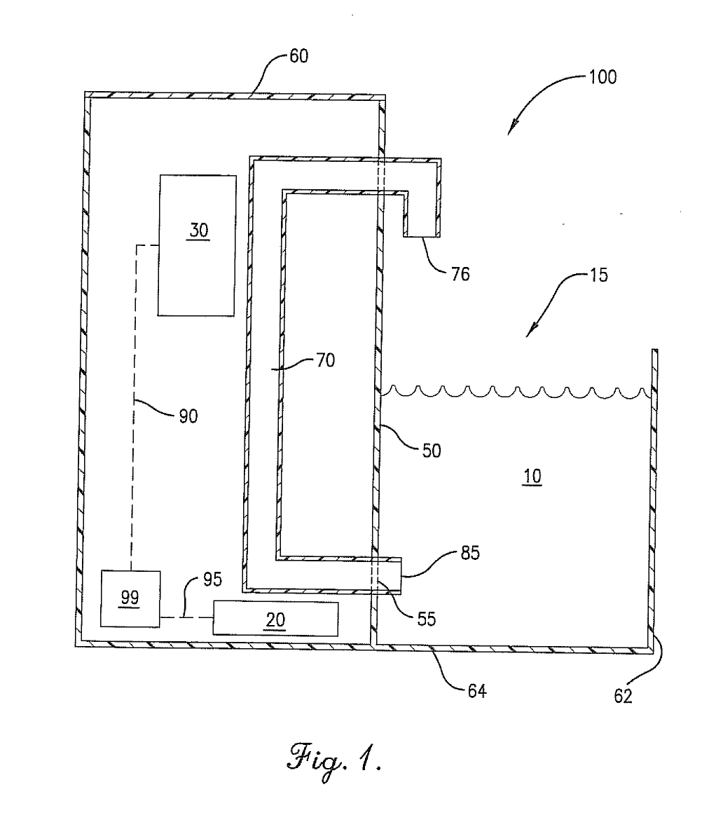

In one aspect, an embodiment of the invention comprises a system 100 as shown in FIG. 1. System 100 is a liquid dispenser suitable for use as a dispenser for potable water for a pet. System 100 comprises liquid-holding section 15. Liquid-holding section 15 comprises a concavity formed by retaining wall 62, bottom surface 64, and retaining wall 50. Walls 50 and 62, and surface 64, of liquid-holding section 15 are formed of any suitable, water-proof material, such as glass, ceramic, metal, plastic, or any other materials known to those of skill in the art. The top of liquid-holding section 15 is uncovered, to allow liquid to be inserted into and removed from section 15. The concavity of section 15, during operation, holds liquid 10 which may be water or any other liquid desired for dispensing to a user, such as a pet. Those of ordinary skill will understand that, although section 15 in FIG. 1 is shown as having a rectangular cross-section, liquid-holding section 15 need not have a rectangular cross-section, but may have any cross-sectional shape as long as there exists a concavity or other suitable region within section 15 for holding a liquid, such as cup-shape, bowl-shaped, saucer-shaped, cylindrical, oval, hemispherical, perfectly square, or any shape suitable for use as a pet's water bowl.

Dispenser 100 comprises disinfecting section 60. Disinfecting section 60 comprises a tube 70 in fluid communication with liquid 10 held in liquid-holding-section 15. Tube 70 includes an inlet 85 through which liquid 10 from section 15 may pass into tube 70. Tube 70 also includes an outlet 76 by which fluid passes back to section 15 after being processed within disinfecting section 60. Tube 70 may be made of one continuous tube, several tubes joined together in conventional ways, or multiple lumens. Tube 70 may be made of any suitable liquid-retaining materials, such as plastic, metal, glass, or ceramic.

Disinfecting section 60 includes pumping section 20. Pumping section 20 is any conventional liquid pump which operates on the liquid within tube 70. Pumping section 20 draws liquid through inlet 85 from holding section 15, pumps the liquid through tube 70, and ultimately impels liquid so that the liquid exits tube 70 from outlet 76. Liquid exiting outlet 76 then returns to the concavity in liquid holding section 15. In this manner, liquid 10 in holding section 15 can be seen to be cycling from section 15, through tube 70 within disinfecting section 60, and back to holding section 15. One of ordinary skill will also recognize that the operation of returning liquid from outlet 76 back to holding section 15 will cause liquid 10 to become aerated. For some pets or other applications, aerated liquid 10 may have benefits such as more refreshing taste for a pet.

Disinfecting section 60 also includes sterilizing section 30. In one embodiment, sterilizing section 30 comprises an ultra-violet light generator which shines ultra-violet light on the liquid within tube 70 as the liquid passes through tube 70 in the direction from inlet 85 to outlet 76. In one embodiment, tube 70 is formed of a material which allows ultra-violet light to pass through the material of the tube 70, so that the ultra-violet light generated by sterilizing section 30 can impact the liquid within tube 70. Ultra-violet light from sterilizer 30 disinfects and sterilizes the liquid within tube 70, through action of the ultra-violet light to kill micro-organisms such as bacteria, viruses, mold spores, funguses, oocysts (such as cryptosporidium, taxoplasma, and giardia), and other biological, microbiological, or other contaminants. Sterilizing section 30 is mounted within disinfecting section 60 such that the ultra-violet light generated by sterilizer 30 is directed or concentrated on the liquid within tube 70. The housing of disinfecting section 60 is made of any opaque material, such as plastic, metal, wood, or ceramic such that the ultra-violet light generated by sterilizer 30 does not escape the interior of section 60.

In another embodiment, disinfecting section 60 includes vents, holes, or decorative features which allow some ultra-violet light to be reflected from the interior of section 60 to the exterior of section 60. In another embodiment, the interior surfaces of the housing of disinfecting section 60 are lined or coated with a reflective material, to allow the ultra-violet light from sterilizer 30 to be reflected back upon the liquid in tube 70, to increase the disinfecting properties of sterilizer 30. In another embodiment, sterilizing section 30 may also include mechanical filters, carbon filters, charcoal filters, or other filtration systems in fluid connection with the liquid within tube 70, to provide additional filtration and sterilization for the liquid within tube 70.

Disinfecting section 60 includes a power control section 99. Power control section 99 may include either a connector to a conventional external power supply, through a power cord, or may include an internal power supply, such as one or more batteries, or both. Because the required power for operating the UV light and pump may be around 15 watts, battery size for an internal power supply may be relatively large which may effect physical form factor, although more powerful and efficient batteries of smaller size may be adaptable to systems, as well as conventional rechargeable batteries. Moreover, if a system is to be used in an environment exposed to sunlight, a solar rechargeable battery may be optionally used. Power control section 99 is in electrical connection with pumping section 20 and sterilizing section 30 to provide power needed for operation of those sections. Power control section 99 includes user-interface or user-controls such as on-off switches or buttons for either or both pumping section 20 and sterilizing section 30; pump speed controls for regulating the speed with which liquid is cycled from holding section 15 through disinfecting section 60 and back to holding section 15; timers for allowing a user to set one or more desired times, recurrent times, or lengths of time for the operation of pumping section 20 or sterilizing section 30, or both; and a user interface for providing the user with helpful or desired information, such as liquid temperature (which is connected to a thermometer, not shown, located in a convenient location in the cycling flow of the liquid), time/date, battery life remaining (if batteries are included), or error messages. Power control section 99 in one embodiment comprises a liquid crystal display controlled by a microcontroller or microprocessor, for displaying appropriate information or messages to a user

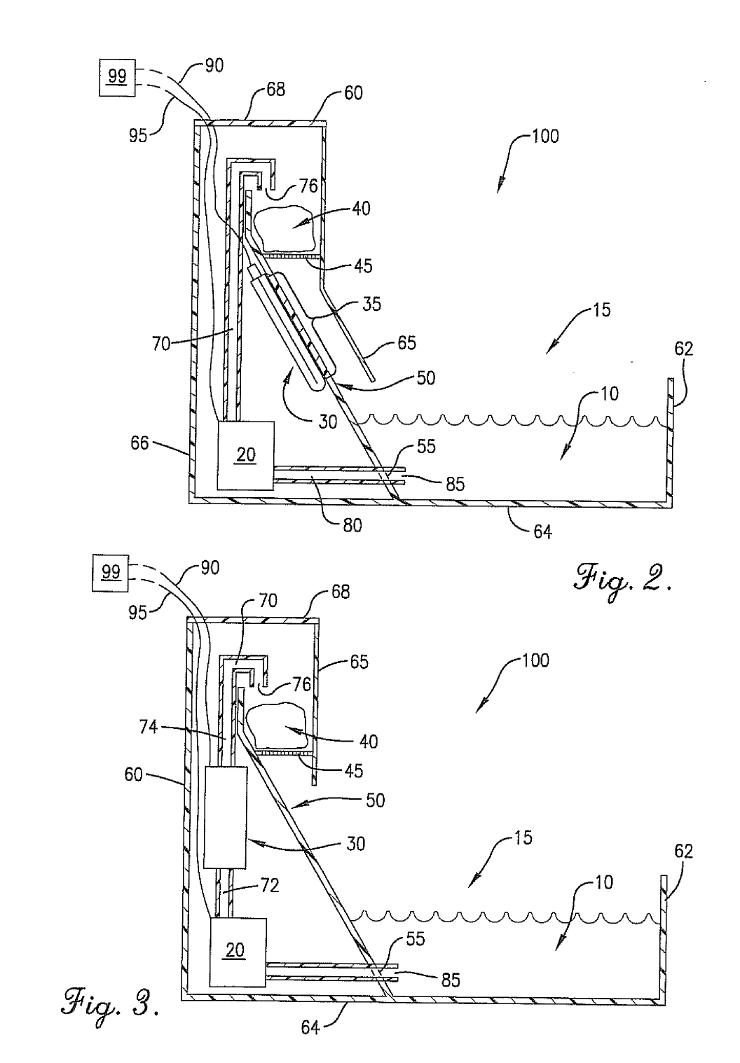

FIG. 2 illustrates a cross-section view of one embodiment of a dispenser 100 in accordance with one embodiment of the present invention. In FIG. 2, liquid 10 is held within liquid-holding section 15. Liquid-holding section 15 comprises a concave area, open at the top. The concavity of section 15 is formed from wall 62, bottom surface 64, and slating wall 50. As shown in FIG. 2, the lower portion of slanting wall 50 operates to act as part of the retaining wall for the concavity of liquid holding section 15. The upper portions of slanting wall 50 are within the interior of disinfecting section 60 and serve additional functions as discussed further below. Slanting wall 50 may be made of one continuous piece of material, or from several pieces joined together in a conventional manner as long as wall 50 is waterproof. Liquid 10 held within section 15 should remain stable and at a level that it does not typically spill out of holding section 15 during normal use, absent external agitation.

Those of ordinary skill will understand that the cross section of liquid holding section 15 in FIGS. 1 and 2 is exemplary only and that section 15 may have any cross-sectional shape as long as there exists a concavity or other suitable region within section 15 for holding a liquid.

System 100 as shown in FIG. 2 includes inlet tube 80, which has an opening inlet 85 in fluid connection with liquid 10 in liquid holding section 15. Tube 80 extends through a water-tight aperture 55 in retaining wall 50 in a water-tight manner such that liquid 10 does not leak into the interior portion of disinfecting section 60. Liquid 10 from liquid holding section 15 is drawn through inlet 85 into tube 80 by action of pump 20. Pumping section 20 is a conventional liquid pump in fluid connection with liquid 10 within tube 80. After pumping section 20 draws liquid from liquid holding section 15 through inlet 85 along tube 80, pumping section 20 then pumps the liquid through tube 70. Tube 70 is connected to pumping section 20 at a first end. The second end of tube 70 includes an outlet 76. In one embodiment, the second end of tube 70 is approximately U-shaped or bent to allow the liquid pumped by pump 20 to exit from outlet 76 and fall by operation of gravity from that point onward. Tube 70 is made of a suitable transparent or semi-transparent material such as glass, plastic, or other similar waterproof material which is also light-transmissive or translucent.

Sterilizing section 30 is mounted on the side of retaining wall 50 interior to disinfecting section 60, such that sterilizer 30 is near tube 70 and substantially co-planar with retaining wall 50. Sterilizing section 30 comprises a UV (ultraviolet) light generator. In operation, sterilizing section 30 shines ultraviolet light onto tube 70, which is formed of a material which allows ultraviolet light to pass through tube 70 and affect the liquid 10 therein. In this manner, in operation sterilizing section 30 sterilizes liquid 10 passing through tube 70 as the liquid 10 passes by action of pump 20 towards outlet 76.

Pump 20 and sterilizer 30 are connected via connectors 90 and 95 to power source 99. Power source 99 may also include control elements for controlling the operation of pump 20 and sterilizer 30.

As shown in FIG. 2, disinfecting section 60 is formed with a housing having a top surface 68 and walls 66. The bottom surface of disinfecting section 60 is formed of a continuation of bottom surface 64. The housing for disinfecting section 60 may be formed of any suitable material such as plastic, glass, metal, or any sufficiently waterproof material.

As shown in FIG. 2, wall 50 is angled or slanted to form a ramp or surface down which liquid may travel from outlet 76, from the interior of housing of disinfecting section 60 back into the concavity of liquid holding section 15. As shown in FIG. 2, in one embodiment the uppermost portion of wall 50 may be angled upwards to create a barrier such that liquid exiting from outlet 76 does not enter into the interior portions of disinfecting section 60, thereby ensuring that the electrical components such as pumping section 20 and disinfecting sections 30 are not negatively affected by moisture.

In another embodiment, wall 50 is connected to grate 45 located beneath outlet 76. In this embodiment, a filter device 40, such as a bag of activated carbon or charcoal, is placed upon grate 45 within the path of liquid 10 exiting from outlet 76. In this embodiment, additional filtration is provided for liquid 10 within system 100 by operation of filtering device 40 as the liquid 10 passes through carbon/charcoal filter 40. In operation, liquid 10 pumped by pump 20 through tube 70 and ultimately out through outlet 76 will pass through filtration device 40 and through grate 45 onto the slanted portion of wall 50.

In one embodiment, a window 35 is included in a portion of wall 50 as shown in FIG. 2. Window 35 is located adjacent to sterilizer 30 such that UV light from sterilizer 30 will transmit through window 35 and affect liquid passing over window 35 along the slanted portion of wall 50. Window 35 is formed integrally within wall 50, and window 35 is made of any suitably transparent or light transmissive material such as glass, plastic or any combination thereof. Window 35 within wall 50 is also mounted within wall 50 in a watertight manner such that liquid falling out of outlet 76 onto wall 50 and over window 35 continues down window 35 and does not leak into the interior portion of the housing of disinfecting section 60. In this manner, disinfecting section 60 provides further sterilizing effect to liquid cycling through system 100 as the liquid 10 passes down wall 50 and over window 35, through which sterilizer 35 shines, back towards concavity 15 of liquid holding section 15. As shown in FIG. 2, the housing of disinfecting section 60 includes a wall 65 which is substantially parallel to window 35 such that ultraviolet light passing through window 35 does not exit directly to the exterior of the housing of disinfecting section 60. This exterior wall 65 of disinfecting section 60 may, as shown in FIG. 2, be constructed parallel to wall 50, but those of ordinary skill will understand that wall 65 need not have such angular relation to wall 50 to achieve a function of blocking ultraviolet light from sterilizer 30.

Accordingly, as shown in FIG. 2, during operation liquid 10 passes through inlet 85 from a concavity of liquid holding portion 15, along tube 80 through pump 20, along tube 70, through outlet 76, through filtration device 40 and grate 45, and past window 35 in wall 50, and hence returns to the concavity in liquid holding section 15. The passage of liquid 10 through this described cycle allows sterilizing section 30 to sterilize the liquid both as it passes through tube 70 and past window 35. In this manner, system 100 provides disinfected liquid for use by a user such as a pet. Those of ordinary skill will understand that tube 70 need not be made of a transparent or light-transmissive material, and that in such an embodiment the sterilizing effect of sterilizer 30 is achieved through the use of window 35 allowing UV light from sterilizer 30 to impact liquid 10 as it passes down ramp wall 50 and over or on window 35 on the way back to liquid holding portion 15. Conversely, those of ordinary skill will understand that wall 50 need not include window 35, and that in such an embodiment, the disinfecting effect of sterilizer 30 is achieved through the use of transparent or light-transmissive material of tube 70 allowing UV light to impact the liquid 10 therein.

FIG. 3 illustrates another preferred embodiment in cross-sectional view of a dispenser 100 in accordance with principles of the present invention. The embodiment of system 100 in FIG. 3 is similar in most respects to the features of the embodiment shown in FIG. 2. In the embodiment of FIG. 3, there is no window 35 in wall 50. As shown in FIG. 3, sterilizing section 30 is mounted in-line with tube 70. Sterilizing section 30 in FIG. 3 generates ultraviolet light directed inward or in a direction substantially orthogonal to the major axis of tube 70. As shown in FIG. 3, tube 70 comprises a lower portion 72, which at a first end is connected to pumping section 20, and at the second end is in-line with sterilizing section 30. Tube 70 continues through or past sterilizing section 30 such that section 74 of tube 70 is not directly next to sterilizing section 30.

In operation, accordingly, the system 100 of FIG. 3 uses pumping section 20 to draw liquid 10 from the concave portion of liquid holding section 15 from inlet 85 through tube 80. The operation of pump 20 pumps liquid 10 from tube 80 and through sections 72 and 74 of tube 70. As liquid passes through tube 70 past sterilizing section 30, sterilizing section 30 generates ultraviolet light which sterilizes liquid within the lumen of tube 70. The operation of pump 20 impels the liquid 10 out of tube 70 through outlet 76. The liquid exiting outlet 76 passes through filtration device 40 and grate 45, and down slanted portion of wall 50 back into concave portion of liquid holding section 15. In the embodiment of FIG. 3, there is no need for a shielding wall 65 to prevent ultraviolet light from unduly exiting from the interior portion of disinfecting section 60 because wall 50 blocks UV light from exiting the interior of section 60.

In the embodiments shown in FIGS. 2 and 3, housing walls 65 or 68 may include a selectively openable door or aperture through which a user may insert, adjust, or remove filtration device 40, clean grate 45 as needed, or clean window 35, as needed.

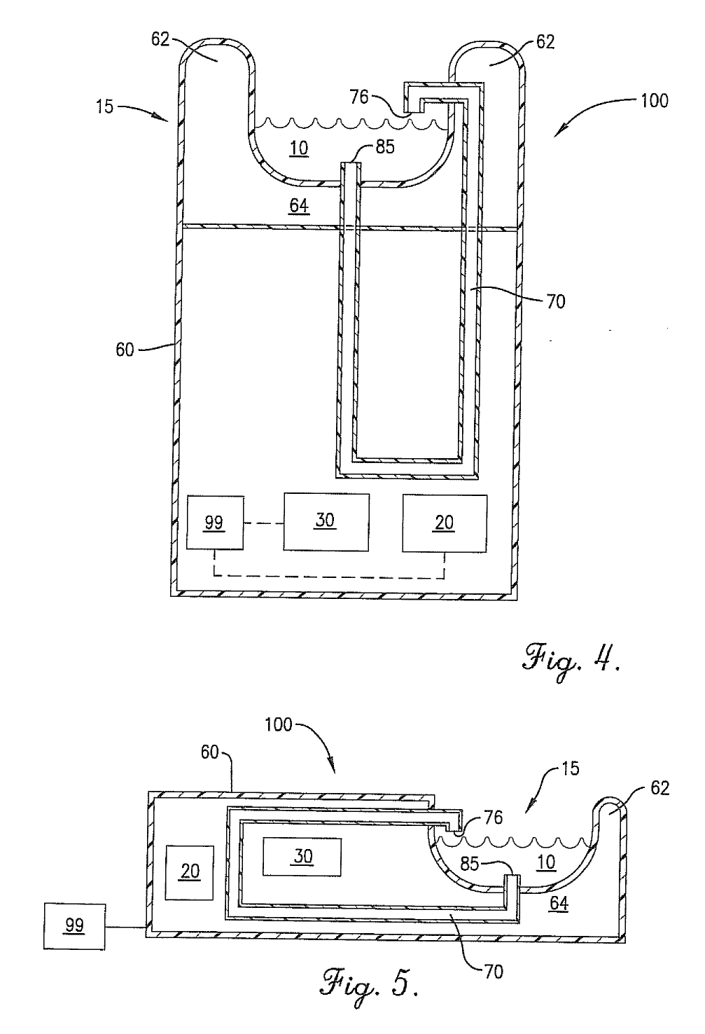

FIG. 4 illustrates a cross-sectional view of another embodiment of dispenser system 100 in accordance with the present invention. As shown in FIG. 4, the physical arrangement of disinfecting section 60 and liquid holding section 15 is such that liquid holding section 15 sits atop disinfecting section 60. The internal elements of the embodiment of FIG. 4 operate similarly as described with respect to FIGS. 1, 2 and 3. The arrangement of disinfecting section 60 beneath liquid holding section 15 allows system 100 to take up less area (such as floor space), and may be suitable for use with taller pets.

As shown in FIG. 4, system 100 in operation includes a concavity within liquid holding section 15 which contains liquid 10. A tube 70 has an inlet 85 in fluid connection with the liquid 10 held within liquid holding section 15. Liquid holding section 15 is formed with sidewalls 62 and a bottom surface 64. Liquid 10 travels by force of gravity into inlet 85 of tube 70. Pump 20 is in fluid connection with the liquid 10 within tube 70. Pump 20 pumps the liquid 10 past sterilizing section 30 and along tube 70 ultimately through outlet 76. In this manner, liquid 10 is disinfected or treated by sterilizing section 30 as liquid 10 passes through an appropriately transparent or light-transmissive portion of tube 70. The operation of pump 20 and sterilizing section 30 are controlled by and powered by power control section 99. The embodiment of FIG. 4 is constructed such that the elements of pump 20 and sterilizing section 30 are placed closer to the bottom surface 64 within the interior of the housing of disinfecting section 60 to provide more stability to the overall structure of system 100. Those of ordinary skill in the art will recognize that additional weights or selection of materials for the housing of section 60 or section 15 can provide additional stability for the overall system 100.

FIG. 5 illustrates in cross-section view another embodiment of a dispensary system 100 in accordance with the present invention. The features of the embodiment of FIG. 5 operate similarly as described with respect to the embodiments of FIGS. 1, 2, 3, and 4. In FIG. 5, disinfecting section 60 is arranged side by side with liquid holding section 15 in a manner such that the two sections are approximately the same height. In the embodiment of FIG. 5, liquid holding section 15 may be constructed in a manner broader in width to allow multiple pets to drink from the concavity of liquid holding section 15 simultaneously.

As shown in FIG. 5, liquid 10 is drawn through inlet 85 of tube 70 by pump 20. Pump 20 pumps liquid through tube 70 past sterilizing section 30, which generates UV light. Tube 70 is formed of a suitable transparent or light-transmissive material. The operation of pump 20 allows the liquid to exit from tube 70 through outlet 76 and thence back into the concavity of liquid holding section 15.

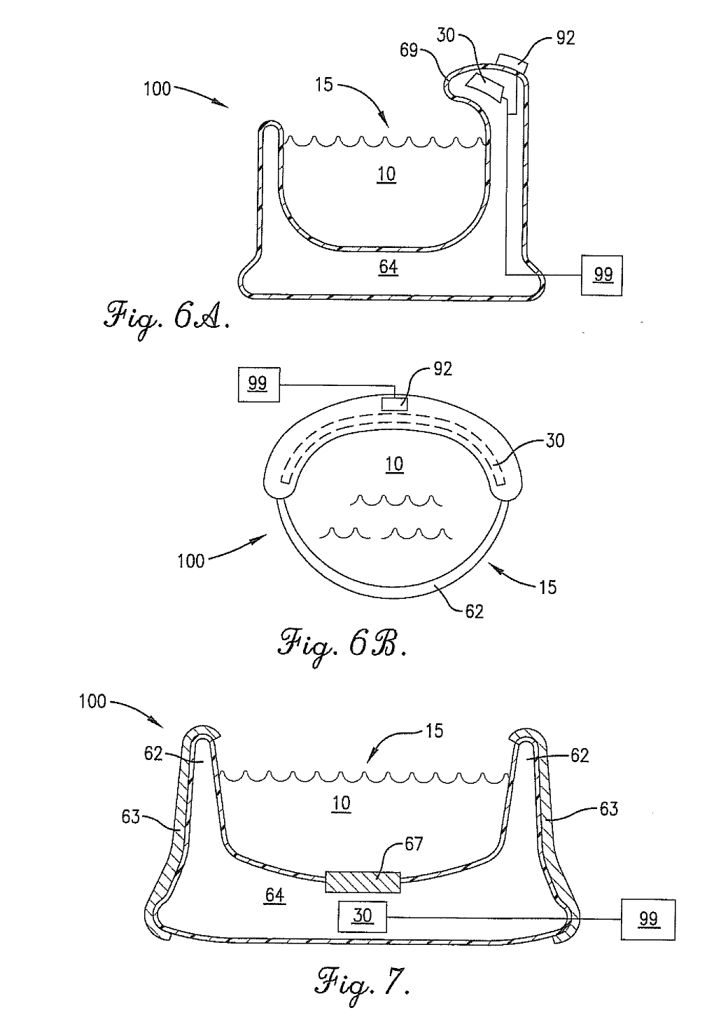

FIGS. 6A and 6B illustrate in cross-section and top view another embodiment of dispenser 100 in accordance with the present invention. As shown in FIG. 6A, sterilizing section 30 is mounted within an upper portion of side wall 62 of liquid containing section 15. The upper portion of wall 62 comprises an overhang 69 which prevents a user or pet from directly viewing the ultraviolet light emanating from sterilizing section 30. As shown in FIG. 6B, sterilizing section 30 is formed partially around the perimeter of the liquid retaining portion 15, and in one embodiment is hemispherical along the rim of liquid containing portion 15. In operation, ultraviolet light from sterilizing portion 30 is directed through a sufficiently light transmissive or transparent section of wall 62 into liquid 10 held within the concavity of liquid containing portion of 15. In this manner, sterilizing section 30 operates on liquid 10 to disinfect the liquid as it is held within the concavity of liquid containing portion 15. As shown in FIGS. 6A and 6B, power controller section 99 provides power to sterilizer 30, as well as user interface controls. In another embodiment, a user interface portion 92 may be mounted upon the top surface of section 69 of sidewall 62. User interface portion 92 may include a liquid crystal display and user-operated switches or buttons for controlling the operation of disinfecting portion 30.

FIG. 7 illustrates another embodiment of a dispenser 100 in accordance with the principles of the present invention. As shown in FIG. 7, liquid holding portion 15 includes a concavity holding liquid 10. The concavity of holding portion 15 is formed of sidewalls 62 and bottom surface 64. The material forming walls 62 and bottom surface 64 is light transmissive, transparent, translucent, or similarly light-transmissive as described with respect to tube 70 and window 35 above. Within the bottom surface of the concavity of liquid holding portion 15 there is opaque portion 67, which does not allow light to pass directly through that portion of bottom surface 64. Opaque portion 67 protects a user or a pet from viewing UV light directly. Sterilizing section 30 is mounted within an interior chamber within bottom surface 64.
In operation sterilizing section 30 transmits ultraviolet light, which is reflected and refracted through the material of sidewall 62 into the concavity of liquid holding portion 15. In this manner, sterilizing section 30 will sterilize liquid 10 as liquid 10 sits within the concavity of liquid holding portion 15. As shown in FIG. 7, sidewalls 62 include covering material 63, which blocks ultraviolet light from sterilizing section 30 from escaping through the sidewalls of holding section 62. In one embodiment, the interior surfaces of material 63 may be coated or lined with a reflective layer or material, such that UV light generated by sterilizer 30 is reflected off that interior surface into the concavity of liquid holding section 15.

In another embodiment, system 100 of the embodiments shown above may include a motion sensor in electrical connection with pumping section 20 or sterilizing section 30, or both. In operation, such a motion sensor would be arranged to detect motion near system 100 (such as when a pet or owner approaches the system), and such sensor output interrupt or control signals which turn off pump 20 or sterilizer 30 (or both) whenever nearby motion is detected. Alternatively, such a motion detector could be arranged to output a control signal which turns on pump 20 or sterilizer 30 whenever nearby motion is detected.

In another embodiment, system 100 of the embodiments shown above may include a water reservoir or storage tank for providing additional water reserves in fluid communication with liquid holding portion 15. In operation, such a water reservoir would provide a desired additional amount of water which would lengthen the time required to re-fill the bowl.

It should be noted that the illustrative embodiments above are representative and that it will be apparent to those of ordinary skill in the art that numerous alterations may be made without departing from the scope of the invention or inventive concepts presented herein. The physical arrangements in the embodiments above are also merely examples of disinfecting liquid dispensers in accordance with the present invention, and those of ordinary skill will understand that features of each of the embodiments described above can be combined with features of other embodiments without departing from the scope of the invention. It will be recognized by one of ordinary skill in the art that many of the exemplary items listed with respect to one embodiment could instead be used as elements in another embodiment, and vice versa.

Moreover, the number of tubes 70, pumping sections 20, sterilizing sections 30, and other features of different embodiments described above should not be interpreted as a limitation on the invention. Alternative embodiments of this invention contain more than one tube 70, more than one liquid-holding section 15 (for providing liquid for more than one pet, for example), more than one pumping section 20, or more than one sterilizing section 30. Also, while water has been described as a liquid 10 for use in system 100, those of ordinary skill will understand that other liquids appropriate for a particular use or environment (or mixtures of liquids) could be used in a system 100. Those of ordinary skill will understand that sterilizer 30 and filtration device 40 need not completely eliminate absolutely all micro-organisms or contaminants from liquid 10, and that the use of terms such as “disinfecting” or “sterilizing” is not intended to require liquid 10 to be 100% completely free of contaminants at all times, but rather that a reasonable level of disinfecting or sterilization for the intended purpose of system 100 is merely required.

While various embodiments of the invention have been shown and described, it will be apparent to those of ordinary skill in the art that numerous alterations may be made without departing from the scope of the invention or inventive concepts presented herein. Persons of ordinary skill will appreciate that changes can be made to dimensions, sizing, relative dimensions, materials, blends of materials, combinations of materials, connectors, spatial and angular relationships of and between components, and manufacturing processes and other commercial or industrial techniques, all without departing from the scope of the invention. Also, those of ordinary skill will understand that the various components and sub-assemblies described with respect to alternate embodiments may be rearranged, substituted, or combined with each other and that various process steps and sub-processes described above with respect to alternate embodiments may be rearranged, substituted, or combined with each other, all without departing from the scope of the invention. Many elements and subassemblies described above could be chosen or arranged differently by those of ordinary skill in the art, while still embodying the present invention. It will be recognized by one of ordinary skill in the art that combining multiple features from different embodiments is within the scope of the present invention. It will be recognized by one of ordinary skill in the art that the separate elements used to form the elements of system 100 can be connected in numerous ways. How the elements are specifically linked will depend on the shape and the material of the elements. One of ordinary skill in the art will recognize the materials needed to make the components of system 100 can vary depending on aesthetics, size of pet, desire for portability, or economic efficiency. Specific dimensions discussed with respect to particular embodiments above are not intended to limit the scope of the invention, but to illustrate specific embodiments of the invention. The above descriptions are only examples of the invention's applications and should not be taken as limitations. Accordingly, while the above disclosure of the invention has been particularly shown and described with reference to particular embodiments thereof, it will be understood by those skilled in the art that the foregoing and other changes in form and detail may be made therein without departing from the spirit and scope of the invention. Thus, the invention is not to be limited except in accordance with the following claims and their equivalents, and those of ordinary skill will understand that various adaptations and combinations of features of the embodiments disclosed are within the scope of the invention as defined by the following claims.

What is claimed is:

1. A system for dispensing disinfected liquid comprising:
a liquid containing portion containing a liquid;
a disinfecting portion in liquid communication with said liquid containing portion;
a pump for pumping liquid from liquid containing portion through the disinfecting portion and back to the liquid containing portion;
a sterilizer for sterilizing said liquid as it passes through the disinfecting section,
wherein said sterilizer generates ultraviolet light sufficient to have anti-bacterial effect on the liquid as the liquid passes through the disinfecting section.

2. A system in accordance with claim 1:
wherein said disinfecting portion includes a UV light generator mounted in line with said tube.

3. A system in accordance with claim 1, further comprising:
a supplemental water reserve tank in fluid communication with said concavity for providing additional water for said system.

4. An apparatus for providing disinfected liquid suitable for use with a pet comprising:
a bowl containing a liquid, said bowl having sidewalls and a bottom surface,
a sterilizer mounted within the interior of the structure of said bowl;
said sterilizer generating ultraviolet light and arranged so as to direct said ultraviolet light at a liquid held within the concavity of said bowl, whereby the sterilizer provides antibacterial effect for sterilizing the liquid held within said bowl.

5. An apparatus in accordance with claim 4, further comprising:
a supplemental water reserve tank in fluid communication with said bowl for providing additional water for said system.

6. A system for dispensing disinfected liquid comprising:
a concavity holding a liquid,
a tube in fluid communication with said liquid,
said tube connected to a pump mounted within a housing adjacent to said concavity;
said tube formed of a light transmissive material,
a UV light generator mounted adjacent to said tube,
said tube having an outlet whereby said pump pumps liquid through said tube and out said outlet onto a return having a light transmissive window, whereby said sterilizer is mounted adjacent to said window, wherein said liquid exiting said outlet travels over said window, and is sterilized by said UV light generator,
wherein liquid cycles through said dispenser system from said concavity and back to said concavity while being sterilized by said UV light generator.

7. A system in accordance with claim 6, further comprising:
a UV light generator mounted in line with said tube.

8. A system in accordance with claim 6, further comprising:
a supplemental water reserve tank in fluid communication with said concavity for providing additional water for said system.
